(19) United States
(12) Patent Application Publication
(10) Pub. No.: US 2003/0154312 A1
(43) Pub. Date: Aug. 14, 2003

(54) Architecture for connection and aggregation of components within a rack

(75) Inventors: Neil Clair Berglund, Mantorville, MN (US); Patrick Allen Buckland, Austin, TX (US); Thomas James Osten, Rochester, MN (US)

Correspondence Address: Gero G. McClellan, Moser, Patterson & Sheridan, L.L.P., Suite 1500, 3040 Post Oak Boulevard, Houston, TX, 77056-6582, US

(73) Assignee: International Business Machines Corporation, Armonk, NY (US)

(21) Appl. No.: 10/074,816

(22) Filed: Feb. 13, 2002

(51) Int. Cl. G06F 15/16

(52) U.S. Cl. 709/250; 709/245

(57) ABSTRACT

The present invention generally is directed to an apparatus for holding one or more devices, comprising a rack. The rack includes one or more devices in which at least one device has a microcontroller. The rack further includes a device memory associated with each device containing a unique identifier. The microcontroller is connected to the device memory through a bus. The microcontroller is configured to retrieve the unique identifier.

### BACKGROUND OF THE INVENTION

1. Field of the Invention

The present invention generally relates to inventory administration, and more particularly to inventory administration of devices located in a rack.

2. Description of the Related Art

Many devices, such as computers, are stored in an equipment room. These devices are typically mounted on a rack to conserve floor space, to protect them from physical hazards, and to make their administration more convenient. After these devices are installed by one or more installers, for instance, one (e.g., a system administrator) may want to know whether these devices are mounted in the their proper racks. Since the system administrator did not install these devices himself, he has no idea whether the devices are mounted in their proper racks. Thus, he would have to take an inventory of these devices manually, i.e., by visually identifying which device belongs to which rack. This can be a tedious and laborious task.

Therefore, there exists a need for a method to programmatically take an inventory of these devices that are mounted in the racks.

### SUMMARY OF THE INVENTION

The present invention generally is directed to an apparatus for holding one or more devices, comprising a rack. The rack includes one or more devices in which at least one device has a microcontroller. The rack further includes a device memory associated with each device containing a unique identifier. The microcontroller is connected to the device memory through a bus. The microcontroller is configured to retrieve the unique identifier.

In accordance with another embodiment, the present invention is directed to an apparatus for holding one or more devices, comprising a rack, which includes one or more devices mounted on the rack. Each device has a device memory and at least one device has a microcontroller. The rack further includes a rack memory containing information about the rack. The microcontroller is connected to the rack memory through a bus. The microcontroller is configured to retrieve the information about the rack.

In accordance with another embodiment, the present invention is directed to a microcontroller that includes a memory containing a device-inventory program and a processor which, when executing the device-inventory program, performs an operation. The operation includes the following steps: receiving a request command; issuing a retrieve command to one or more memories connected to the microcontroller in response to receiving the request command. The retrieve command is configured to retrieve inventory information from the one or more memories. The operation further includes the step of receiving the inventory information from the one or more memories. The inventory information contains one of information about a device and information about the rack. The operation further includes the step of sending the inventory information to a user interface.

In accordance with yet another embodiment, the present invention is directed to a method of programmatically taking an inventory of one or more devices. Each device is mounted on a rack. The method includes the steps of receiving a request command from a user interface communicably linked to a microcontroller in each device; and issuing a retrieve command to one or more memories connected to the microcontroller in response to receiving the request command. The retrieve command is configured to retrieve inventory information from the one or more memories. The method further includes the steps of receiving the inventory information from the one or more memories; and sending the inventory information to the user interface.

In accordance with another embodiment, the present invention is directed to a computer-readable medium containing a program which, when executed by a processor, performs an operation of taking an inventory of one or more devices. Each device is mounted on a rack. The operation includes the following steps: receiving a request command from a user interface communicably linked to a microcontroller in each device; and issuing a retrieve command to one or more memories connected to the microcontroller in response to receiving the request command. The retrieve command is configured to retrieve inventory information from the one or more memories. The operation further includes the steps of receiving the inventory information from the one or more memories; and sending the inventory information to the user interface.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrative of a rack in accordance with an embodiment of the present invention;

FIG. 2 is a block diagram illustrative of a rack in accordance with another embodiment of the present invention;

FIG. 3 is a block diagram illustrative of a rack in accordance with yet another embodiment of the present invention;

FIG. 4 is a flowchart of a process of programmatically taking an inventory of the devices mounted on the rack in accordance with an embodiment of the present invention;

FIG. 5 is a block diagram illustrative of a rack in accordance with yet another embodiment of the present invention; and

FIG. 6 is a block diagram illustrative of the memory in accordance with an embodiment of the present invention.

### DETAILED DESCRIPTION OF THE PREFERRED EMBODIMENTS

The present invention generally is directed to a rack in which one or more devices are mounted. At least one device has its own microcontroller. A device memory that contains information about the device is placed on each device. The microcontroller is connected to the device memory through a single wire bus. The microcontroller is configured to retrieve the information from the memory when it receives a request command. In one embodiment, the microcontroller receives the request command from a user interface. The user interface may be remote from the rack or it can be part of the rack itself. The device may also include the user interface. The rack may further include a rack memory that contains information about the rack. This rack memory is also connected to the microcontroller, which is configured to retrieve information from the rack memory. In one embodiment, the microcontroller is configured to retrieve information from all memories connected to it through the bus. Using the information retrieved from the memories, a system administrator can make a determination that all the devices with the device memory attached to them are mounted in/on one rack. The device memory may further be personalized with information about the device itself to provide more meaningful information. He can further determine physical association between devices and the rack since the information contained in the memories can contain device and rack size information. The administrator can further determine how much relative space is left in the rack for installation of additional devices or other configuration purposes.

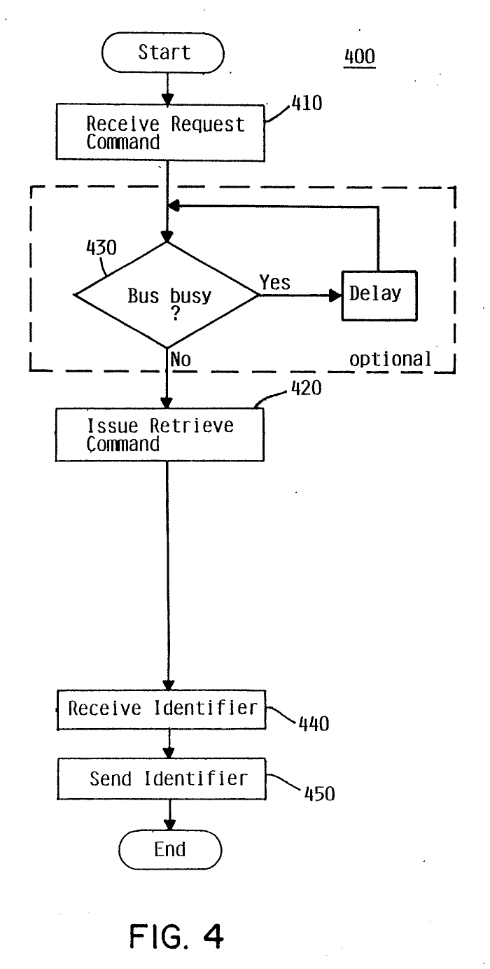

One embodiment of the invention is implemented as a program product for use with a rack, such as the rack 100 and described below. The program(s) of the program product defines functions of the embodiments (including the methods described below with reference to FIG. 4) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

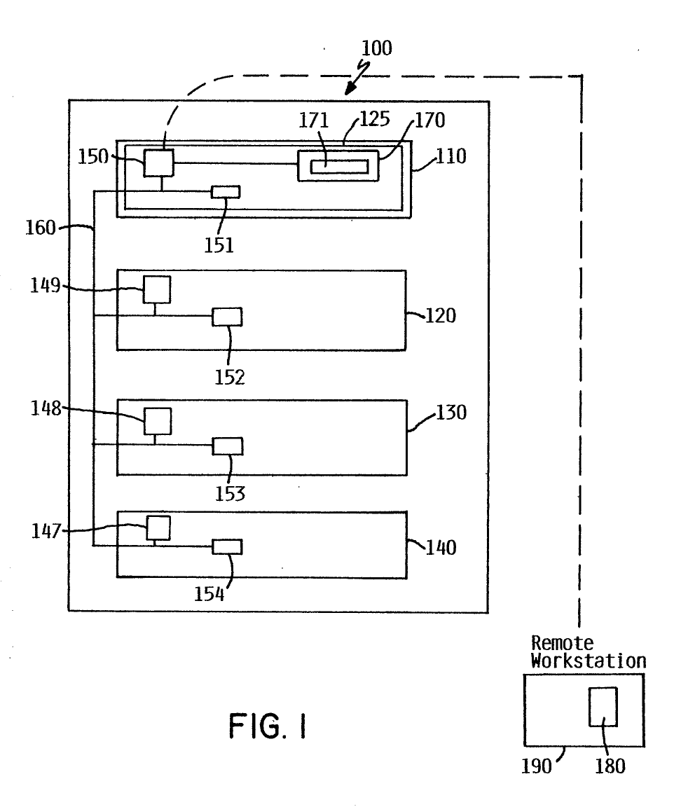

Referring now to FIG. 1, a block diagram illustrative of a rack 100 in accordance with an embodiment of the present invention is shown. The rack 100 includes a group of device 110, 120, 130 and 140. The rack 100, however, is not limited by the number of devices it contains. In fact, the rack 100 may hold any number of devices. The device may be a computer, a switch, or a router. The rack 100 further includes a bus 160. The bus 160 may be a serial bus or a parallel bus. The bus 160 may also be Ethernet, USB, 12C or RS232. In one embodiment, the bus is a Dallas Semiconductor 1-wire bus. The Dallas Semiconductor 1-wire bus is a single-wire, multi-drop bus that is advantageous for connecting the device 110 to the memory 151. FIG. 1 further shows that each device 110 has a microcontroller, e.g., the device 110 includes a microcontroller 150, communicably linked through the bus 160 to a memory 151, referred hereinafter as the device memory 151. The microcontroller 150 may be imbedded in the device 110. Alternatively, the microcontroller 150 may be coupled to the rack 100. FIG. 1 also shows that the device 120 includes a device memory 152, the device 130 includes a device memory 153, and the device 140 includes a device memory 154. The microcontroller 150 is communicably linked through the bus 160 to the device memory 152, the device memory 153 and the device memory 154.

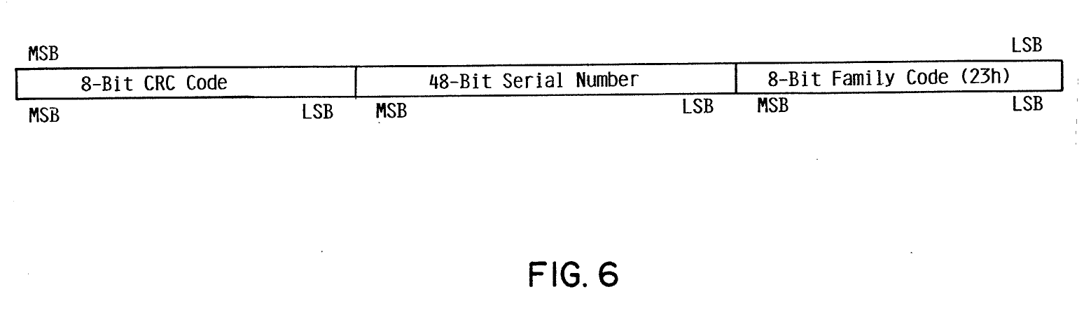

In one embodiment, the memory, e.g., the device memory 151, is an electrically erasable programmable read-only memory (“EEPROM”). Each memory, i.e., the device memory 151, the device memory 152, the device memory 153 and the device memory 154 contains a unique identifier. FIG. 6 illustrates an embodiment of the identifier, which is a unique 64-bit registration number that is factory-lasered, fuse blown or otherwise permanently placed on to the memory. In one embodiment, the identifier is an 8 byte ROM Registration Number (“RRN”). The most significant bits (“MSB”) of the RRN contains a Cyclic Redundancy Check (“CRC”) byte. The next 6 bytes of the RRN make up a unique serial number, which is often referred to as a globally unique identification (“GUID”). The least significant bits (“LSB”) contains a “family code,” which can be used to distinguish between an identifier associated with a rack 100 and another identifier associated with the device 110, 120, 130, and 140 mounted on the rack 100. In one embodiment, the device memory, e.g., the device memory 152, contains information about the rack drawer, such as, the width, height and manufacturer of the rack drawer. In another embodiment, the device memory can be personalized with information about the device, such as, the type, make and model of the device. The device memory, e.g., the device memory 152, may be coupled to the device 120 by glue, solder, clips, cable or any other attachment means commonly used in the art. In one embodiment, the device memory 152 is soldered to the mother board of the device 120.

In accordance with an embodiment of the present invention, the microcontroller 150 is configured to retrieve the information, including the identifier, stored in the memory, e.g., the device memory 151. The device 110 further includes an op panel user interface 170 for communicating with the microcontroller 150 and an LCD 171 for viewing the information, such as the identifier. The op panel user interface 170 is communicably linked to the microcontroller 150. In one embodiment, the op panel user interface 170 contains a push button interface that causes the LCD 171 to display the information when pushed. In accordance with another embodiment, the device 110 includes a PCI LAN card (not shown) for communicably linking the microcontroller 150 to a remote user interface 180 on a remote workstation 190. In this embodiment, the remote user interface 180 is part of a system management application that contains a database, e.g., a common inventory database.

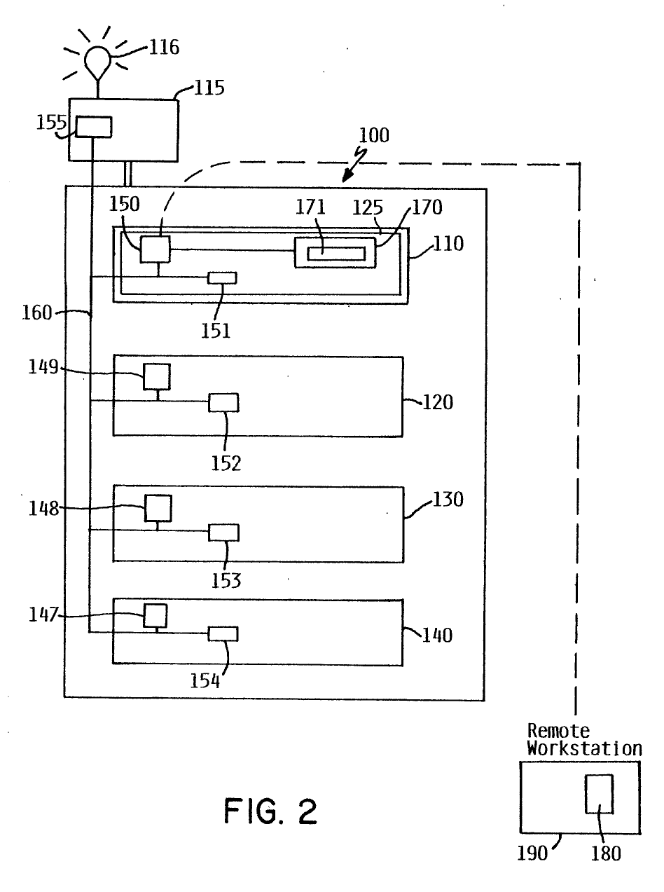

FIG. 2 illustrates another embodiment of the rack 100 that includes a rack light assembly 115 coupled to the rack 100. The assembly 115 includes a memory 155, referred hereinafter as the rack memory 155. The rack memory 155 is connected to the microcontroller 150 through the bus 160. In one embodiment, the rack memory 155 contains a unique identifier associated with the rack. In accordance with another embodiment, the rack memory 155 contains information about the rack, such as, the width, height, and manufacturer of the rack. The microcontroller is also configured to retrieve the information along with the identifier stored in the rack memory 155. In one embodiment, the microcontroller 150 is configured to retrieve information and identifiers from all the memories connected to it. The rack memory 155 may be coupled to the rack light assembly 115 by glue, solder, clips, cable or any other attachment means commonly used in the art. In accordance with an embodiment of the present invention, the rack memory 155 may be coupled to any portion of the rack 100. The rack light assembly 115 may further include a user interface (not shown) and an LCD for displaying information (not shown), and a microcontroller (not shown) to retrieve information from all memories connected to it through the bus 160. The rack light assembly 115 may further include a power supply for supplying power to bus 160, the light bulb 116 and other components (not shown).

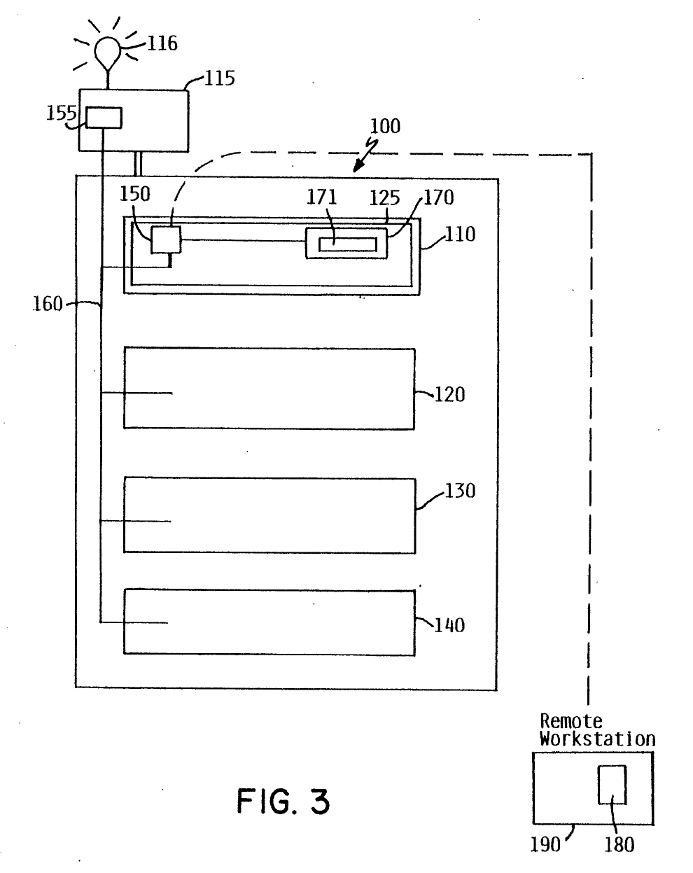

FIG. 3 illustrates another embodiment of the rack 100. The rack 100 includes the device 110, 120, 130 and 140. The device 110 includes the microcontroller 150 communicably linked to either the remote user interface 180 or the op panel user interface 170. The rack 100 further includes the rack light assembly 115, which includes the rack memory 155. The rack memory 155 is connected to the microcontroller 150 through the bus 160. In this embodiment, however, none of the devices has any memory. In this embodiment, only the device 110 can provide the user interface with information about the rack in which it is mounted.

FIG. 4 illustrates a flowchart of a method 400 of programmatically taking an inventory of the devices mounted on a rack in accordance with an embodiment of the present invention, such as the various embodiments illustrated in FIGS. 1-3. The method 400 begins with a microcontroller, such as the microcontroller 150, receiving a request command from a user interface, such as the user interface 170 or 180, as shown in block 410. The request command requests the microcontroller 150 to issue a retrieve command for retrieving inventory information stored in a memory, such as the device memory 151 or the rack memory 155. The request command contains the logical address of the microcontroller 150. In one embodiment, the request command is a software command, while the retrieve command is a firmware command. In response to the request command, the microcontroller 150 issues the retrieve command to the memory, as shown in block 420. In one embodiment, the request command may be transmitted through a series of microcontrollers before a retrieve command is finally issued. In another embodiment, the retrieve command is a read ROM command. In a 1-wire bus system that has a bus master, i.e., the microcontroller 150, and only one slave with an EEPROM, e.g., the rack memory 155, the read ROM command allows the bus master to read the inventory information stored in the EEPROM. In another embodiment, the retrieve command is a search ROM command. The search ROM command allows the bus master, i.e., the microcontroller 150, to use a process of elimination to identify the inventory information of all slave devices, e.g., the device memories, on the bus. The search ROM process is the repetition of a simple 3-step routine: read a bit, read the complement of the bit, then write the desire value of that bit. The bus master performs this simple, 3-step routine on each bit of the ROM. After one complete pass, the bus master knows the contents of the ROM in one of the device memories. The remaining number of device memories and their respective inventory information may be identified by additional passes. In response to the retrieve command, the microcontroller 150 receives the inventory information from the memory, as shown in block 440. In this manner, the memory is configured to send the inventory information to the microcontroller 150 upon receipt of the retrieve command. The inventory information is then sent to the user interface, as shown in block 450.

In accordance with the embodiment illustrated in FIG. 1, the inventory information received by the microcontroller 150 contains inventory information from the device memories 151, 152, 153, and 154, which includes information about the type, make and model of the device in addition to the unique identifier associated with the device. Thus, from the inventory information received by the microcontroller 150 configured in accordance with an embodiment illustrated in FIG. 1, a system administrator can determine that the four devices 110, 120, 130 and 140 are all aggregated in one rack.

In accordance with the embodiment illustrated in FIG. 2, the inventory information received by the microcontroller 150 contains information from the device memories 151, 152, 153, and 154 and the rack memory 155. As mentioned above, each one of the device memories 151, 152, 153, and 154 contains information about the device in addition to the unique identifier associated with the device. The rack memory 155, on the other hand, contains information about the rack 100, such as, the width, height, and manufacturer of the rack 100 in addition to the unique identifier associated with the rack 100. From the inventory information received by the microcontroller 150 configured in accordance with an embodiment illustrated in FIG. 2, a system administrator can determine that all four devices 110, 120, 130 and 140 are all aggregated or associated in one rack, i.e., the rack 100. One difference between the embodiment illustrated in FIG. 1 and the embodiment illustrated in FIG. 2 is that the inventory information received by the microcontroller 150 configured in accordance with the FIG. 2 embodiment contains information about the particular rack on which the devices are mounted. In this manner, the devices mounted in the rack 100 are associated with that rack 100.

In accordance with the embodiment illustrated in FIG. 3, the inventory information received by the microcontroller 150 contains information from the rack memory 155. As such, the inventory information contains only information about the rack 100, such as, the width, height, and manufacturer of the rack 100 in addition to the unique identifier associated with the rack 100. Thus, from the inventory information received by the microcontroller 150 configured in accordance with an embodiment illustrated in FIG. 3, a system administrator, through the logical address of the device 110, can only deduce that the device 110 is located on a rack described by the inventory information. And, in this embodiment, the device is mounted on the rack 100.

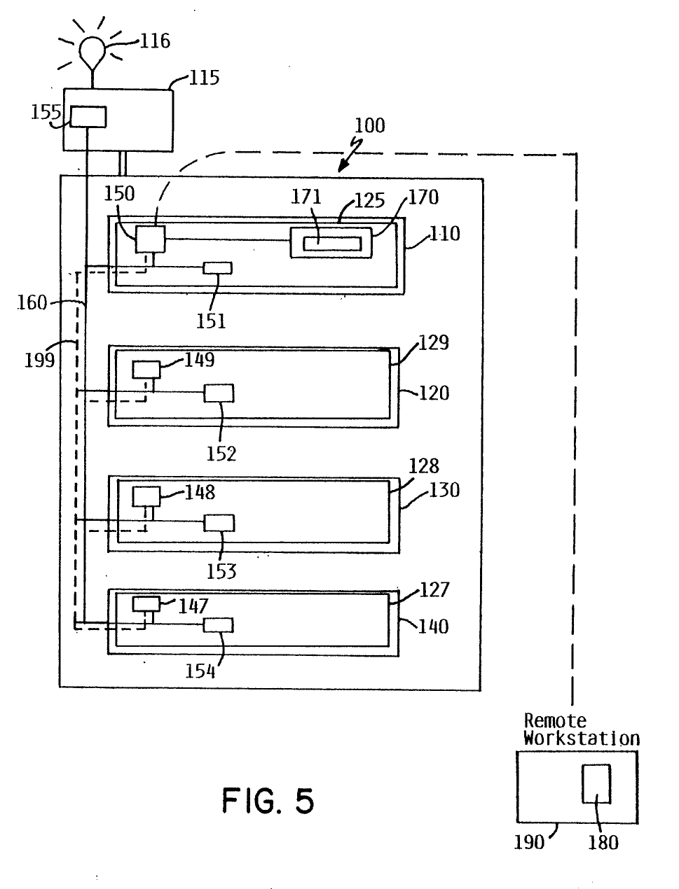

Referring back to the flowchart illustrated in FIG. 4, in accordance with another embodiment, the bus 160 includes an additional wire 199 to indicate to any attached microcontroller (e.g., microcontroller 147, 148, 149 and 150) that the bus 160 is busy (shown in FIG. 5). In an embodiment in which more than one microcontroller attempts to issue a retrieve command at the same time, this wire 199 enables any or all of the microcontrollers that are attempting to issue the retrieve command to first determine whether the bus 160 is occupied, as shown in block 430. If the bus is occupied, it will return a busy message to the microcontrollers. In such cases, the microcontroller issues another retrieve command after a certain time, i.e., after a random time delay. In one embodiment, this process lasts only for a period of time, i.e., a timeout value.

While the foregoing is directed to embodiments of the present invention, other and further embodiments of the invention may be devised without departing from the basic scope thereof, and the scope thereof is determined by the claims that follow.

What is claimed is:

1. An apparatus for holding one or more devices, comprising:
a rack comprising:
one or more device, at least one device having a microcontroller;
a device memory associated with the at least one device, the device memory containing a unique identifier; and
a bus connecting the microcontroller and the device memory, the microcontroller being configured to retrieve the unique identifier.

2. The apparatus of claim 1, wherein the device memory comprises information about the device.

3. The apparatus of claim 1, wherein the rack further comprising a rack memory connected to the microcontroller through the bus, the rack memory containing information about the rack; and the microcontroller being configured to retrieve the information from the rack memory.

4. The apparatus of claim 1, wherein information about the rack comprises a unique identifier associated with the rack.

5. The apparatus of claim 1, wherein the device further comprises a user interface communicably linked to the microcontoller.

6. The apparatus of claim 1, wherein the microcontroller is communicably linked to a user interface.

7. The apparatus of claim 6, wherein the user interface is remote from the rack.

8. The apparatus of claim 1, wherein the bus is a one-wire bus.

9. The apparatus of claim 1, wherein the bus comprises a wire configured to indicate to the microcontroller that the bus is busy.

10. The apparatus of claim 6, wherein the microcontroller contains a device-inventory program; and a processor which, when executing the device-inventory program, performs an operation comprising:
receiving a request command from the user interface;
issuing a retrieve command to the device memory in response to receiving the request command, the retrieve command being configured to retrieve information about the device;
receiving the information about the device; and
sending the the information about the device to the user interface.

11. An apparatus for holding one or more devices, comprising:
a rack comprising:
one or more device, at least one device having a microcontroller;
a rack memory associated with the at least one device, the rack memory containing information about the rack; and
a bus connecting the microcontroller and the rack memory, the microcontroller being configured to retrieve the unique identifier.

12. The apparatus of claim 11, wherein the information about the rack comprises a unique identifier associated with the rack.

13. A microcontroller, comprising:
a memory containing a device-inventory program; and
a processor which, when executing the device-inventory program, performs an operation comprising:
receiving a request command;
issuing a retrieve command to one or more memories connected to the microcontroller in response to receiving the request command, the retrieve command being configured to retrieve inventory information from the one or more memories;
receiving the inventory information from the one or more memories, the inventory information containing one of information about a device and information about a rack; and
sending the inventory information to the user interface.

14. A method of programmatically taking an inventory of one or more devices, each device being mounted on a rack, comprising:
receiving a request command from a user interface communicably linked to a microcontroller;
issuing a retrieve command to one or more memories connected to the microcontroller in response to receiving the request command, the retrieve command being configured to retrieve inventory information from the one or more memories;
receiving the inventory information from the one or more memories; and
sending the inventory information to the user interface.

15. The method of claim 14, wherein the request command is configured to request the microcontroller to issue the retrieve command to the one or more memories.

16. The method of claim 14, wherein the one or more memories comprise one or more device memories, each device memory being coupled to one of the rack and a device.

17. The method of claim 16, wherein each device memory comprises the inventory information containing one of a unique identifier associated with the device and information about the device.

18. The method of claim 14, wherein the one or more memories comprise a rack memory coupled to the rack.

19. The method of claim 18, wherein the rack memory comprises the inventory information containing one of a unique identifier associated with the rack and information about the rack.

20. The method of claim 14, wherein the microcontroller is connected to one of the rack and at least one of the one or more devices.

21. The method of claim 14, wherein the retrieve command is issued by the microcontroller to the one or more memories through a bus.

22. The method of claim 14, wherein issuing the retrieve command comprises:
determining whether a busy message exists; and
if the bus message exists, then issuing another retrieve command to the one or more memories.

23. The method of claim 22, wherein the another retrieve command is issued after a random period of time.

24. A computer-readable medium containing a program which, when executed by a processor, performs an operation of taking an inventory of one or more devices, each device being mounted on a rack, the operation comprising:
receiving a request command from a user interface communicably linked to a microcontroller;
issuing a retrieve command to one or more memories connected to the microcontroller in response to receiving the request command, the retrieve command being configured to retrieve inventory information from the one or more memories;
receiving the inventory information from the one or more memories; and
sending the inventory information to the user interface.

25. The computer-readable medium of claim 24, wherein the request command requests the microcontroller to issue the retrieve command to the one or more memories.

26. The computer-readable medium of claim 24, wherein the one or more memories comprise one or more device memories, each device memory being coupled to the device.

27. The computer-readable medium of claim 26, wherein the inventory information containing one of a unique identifier associated with the device and information about the device.

28. The computer-readable medium of claim 24, wherein the one or more memories comprise a rack memory coupled to the rack.

29. The computer-readable medium of claim 28, wherein the rack memory comprises the inventory information containing one of a unique identifier associated with the rack and information about the rack.
